(19) United States
(12) Patent Application Publication
(10) Pub. No.: US 2026/0111995 A1
(43) Pub. Date: Apr. 23, 2026

(54) METHOD OF IMAGE RENDERING, DEVICE AND STORAGE MEDIUM

(71) Applicant: Beijing Zitiao Network Technology Co., Ltd., Beijing (CN)

(72) Inventor: Tongwei ZHOU, Beijing (CN)

(21) Appl. No.: 19/361,735

(22) Filed: Oct. 17, 2025

(30) Foreign Application Priority Data
Oct. 17, 2024 (CN) 202411456164.5

(51) Int. Cl. G06T 3/4053; G06T 11/00; G06T 15/20; G06T 15/50

(52) U.S. Cl. CPC G06T 3/4053; G06T 11/10; G06T 15/20; G06T 15/503; G06T 2210/21

(57) ABSTRACT

A method of image rendering, a device and a storage medium are provided. The method includes: by a render server, receiving texture content of a 2D application sent by a 2D composite display server; determining an overlapping area between a panel of the 2D application and a central field of view of a user; acquiring an image magnification of the overlapping area, where the image magnification is greater than 1; performing image super-resolution processing on texture content in the overlapping area by using an image super-resolution algorithm, according to the image magnification, to obtain a super-resolution image corresponding to the texture content in the overlapping area; and rendering the panel of the 2D application into XR space according to the super-resolution image.

### CROSS-REFERENCE TO RELATED APPLICATION

The present application claims priority of the Chinese Patent Application No. 202411456164.5, filed on October 17, 2024, the disclosure of which is incorporated herein by reference in its entirety as part of the present application.

### TECHNICAL FIELD

Embodiments of the present disclosure relate to a method of image rendering, a device, and a storage medium.

### BACKGROUND

Extended Reality (XR) refers to the combination of real and virtual through computers to create a virtual environment capable of human-computer interaction. XR is also general term for a plurality of technologies such as Virtual Reality (VR), Augmented Reality (AR) and Mixed Reality (MR). By integrating the visual interaction technologies of the three, it brings the “immersion” of seamless transformation between the virtual world and the real world to the experiencer.

In XR devices, there are multi-task scenarios, that is, a user opens a plurality of applications at the same time, including XR applications (APPs) and traditional 2D APPs, where the content of the 2D APPs is projected into 3D XR space through perspective transformation. However, the screen-to-body ratio of the 2D APP projected into the XR space is very small, which causes a problem of blurring the content of the 2D APP.

### SUMMARY

According to a first aspect, an embodiment of the present disclosure provides a method of image rendering, which is applied to an extended reality XR device. The XR device includes a 2D composite display server and a render server, and the method includes: receiving, by the render server, texture content of a 2D application sent by the 2D composite display server; determining, by the render server, an overlapping area between a panel of the 2D application and a central field of view of a user; acquiring, by the render server, an image magnification of the overlapping area, where the image magnification is greater than 1; performing, by the render server, image super-resolution processing on texture content in the overlapping area by using an image super-resolution algorithm, according to the image magnification, to obtain a super-resolution image corresponding to the texture content in the overlapping area; and rendering, by the render server, the panel of the 2D application into XR space according to the super-resolution image.

In some exemplary embodiments, the acquiring, by the render server, an image magnification of the overlapping area, includes: determining a screen-to-body ratio of a projection of the panel of the 2D application on a display screen and the display screen according to a coordinate of the panel of the 2D application in the XR space; and calculating a reciprocal of the screen-to-body ratio, and determining the image magnification according to the reciprocal of the screen-to-body ratio.

In some exemplary embodiments, the determining a screen-to-body ratio of a projection of the panel of the 2D application on a display screen and the display screen according to a coordinate of the panel of the 2D application in the XR space, includes: determining, according to the coordinate of the panel of the 2D application in the XR space, a screen coordinate of the panel of the 2D application in a screen coordinate system after the panel of the 2D application is projected into the XR space through perspective transformation; determining a projection area of the panel of the 2D application on the display screen according to the screen coordinate of the panel of the 2D application; and calculating a ratio of the projection area of the panel of the 2D application on the display screen to an area of the display screen, and determining the ratio as the screen-to-body ratio.

In some exemplary embodiments, the determining, according to the coordinate of the panel of the 2D application in the XR space, a screen coordinate of the panel of the 2D application in a screen coordinate system after the panel of the 2D application is projected into the XR space through perspective transformation, includes: acquiring a view matrix and a projection matrix for a camera; transforming the coordinate of the panel of the 2D application in the XR space to a cropped space coordinate system according to the view matrix and the projection matrix; and converting a coordinate of the panel of the 2D application in the cropped space coordinate system to the screen coordinate system to obtain the screen coordinate of the 2D application in the screen coordinate system.

In some exemplary embodiments, the rendering, by the render server, the panel of the 2D application into XR space according to the super-resolution image, includes: reading content of the super-resolution image from a first buffer, and projecting the super-resolution image into the XR space through perspective transformation; and reading, from a second buffer, content in other areas in the panel of the 2D application other than the overlapping area, and projecting the content in the other areas into the XR space through perspective transformation.

In some exemplary embodiments, the rendering, by the render server, the panel of the 2D application into XR space according to the super-resolution image, further includes: performing spatial effect processing on the panel of the 2D application.

In some exemplary embodiments, the spatial effect processing includes at least one of following processing selected from the group consisting of: lighting processing, feathering processing, or blurring processing.

In some exemplary embodiments, the determining an overlapping area between a panel of the 2D application and a central field of view of a user, includes: detecting whether an interactive ray in the XR space collides with the panel of the 2D application; determining the panel of the 2D application being overlapped with the central field of view when the interaction ray collides with the panel of the 2D application; determining a position of the central field of view according to a preset size parameter of the central field of view, taking a collision point between the interactive ray and the panel of the 2D application as a center point; and determining the overlapping area according to the position of the central field of view and a position of the panel of the 2D application.

In some exemplary embodiments, the determining an overlapping area between a panel of the 2D application and a central field of view of a user, includes: determining a screen coordinate of the panel of the 2D application in a screen coordinate system after the panel of the 2D application is projected into the XR space according to a coordinate of the panel of the 2D application in the XR space; determining, according to the screen coordinate of the panel of the 2D application, whether the screen coordinate of the panel of the 2D application overlaps with a central region of a range of a screen coordinate corresponding to the XR space; determining the panel of the 2D application being overlapped with the central field of view when the screen coordinate of the panel of the 2D application overlaps with the central region of the range of the screen coordinate corresponding to the XR space; and determining the overlapping area between the panel of the 2D application and the central field of view according to the coordinate of the panel of the 2D application in the XR space.

In some exemplary embodiments, the performing image super-resolution processing on texture content in the overlapping area by using an image super-resolution algorithm, according to the image magnification, to obtain a super-resolution image corresponding to the texture content in the overlapping area, includes: inputting the texture content in the overlapping area and the image magnification to an image super-resolution model, where the image super-resolution model outputs the super-resolution image corresponding to the texture content in the overlapping area.

In a second aspect, an embodiment of the present disclosure provides an apparatus of image rendering, which includes a 2D composite display server and a render server.

The 2D composite display server is configured to process an image of a 2D application to obtain texture content of the 2D application.

The render server is configured to receive the texture content of the 2D application sent by the 2D composite display server.

The render server is further configured to determine an overlapping area between a panel of the 2D application and a central field of view of a user.

The render server is further configured to acquire an image magnification of the overlapping area, and the image magnification is greater than 1.

The render server is further configured to perform image super-resolution processing on texture content in the overlapping area by using an image super-resolution algorithm, according to the image magnification, to obtain a super-resolution image corresponding to the texture content in the overlapping area.

The render server is further configured to render the panel of the 2D application into XR space according to the super-resolution image.

According to a third aspect, an embodiment of the present disclosure provides an XR device. The XR includes: at least one processor and at least one memory. The at least one memory is configured to store a computer program, and the at least one processor is configured to call and run the computer program stored in the at least one memory to perform the method perform the method according to any one of the embodiments in the above first aspect.

According to a fourth aspect, an embodiment of the present disclosure provides a computer-readable storage medium. The computer-readable storage medium is configured to store a computer program, and the computer program causes a computer to perform the method according to any one of the embodiments in the above first aspect.

According to a fifth aspect, an embodiment of the present disclosure provides a computer program product including a computer program, and when the computer program is executed by a processor, the processor is caused to perform the method according to any one of the embodiments in the above first aspect.

### BRIEF DESCRIPTION OF DRAWINGS

In order to more clearly explain the technical solutions in the embodiments of the present disclosure, the accompanying drawings that need to be used in the description of the embodiments will be briefly introduced below, and obviously, the accompanying drawings in the following description are only some embodiments of the present disclosure, and for those skilled in the art, other accompanying drawings can be obtained from these accompanying drawings without creative labor.

FIG. 1 is a schematic flow diagram of a method of image rendering according to an embodiment of the present disclosure.

FIG. 2 is a flowchart of a method of image rendering according to an embodiment of the present disclosure.

FIG. 3 is a schematic diagram of a software architecture of an Android system to which an embodiment of the present disclosure is applicable;

FIG. 4 is a schematic structural diagram of an apparatus of image rendering according to an embodiment of the present disclosure.

FIG. 5 is a schematic structural diagram of an XR device according to an embodiment of the present disclosure.

### DETAILED DESCRIPTION

Hereinafter, the technical solutions in the embodiments of the present disclosure will be clearly and completely described with reference to the accompanying drawings in the embodiments of the present disclosure, and obviously, the described embodiments are only some embodiments of the present disclosure, but not all embodiments. Based on the embodiments in the present disclosure, all other embodiments obtained by those skilled in the art without creative efforts fall within the scope of protection of the present disclosure.

It should be noted that the terms “first”, “second”, and the like in the specification and claims of the present disclosure, and the drawings are used to distinguish similar objects, and are not necessarily used to describe a specific order or sequence. It should be understood that the used data may be interchangeable in an appropriate situation, so that the embodiments of the present disclosure described herein can be practiced in an order other than those illustrated or described herein. Furthermore, the terms “including” and “having” and any variations thereof are intended to cover a non-exclusive inclusion, for example, a process, method, system, product, or server that includes a series of steps or units need not be limited to those steps or units that are clearly listed, but may include other steps or units that are not clearly listed or inherent to such processes, methods, products, or devices.

In order to facilitate the understanding of the embodiments of the present disclosure, before describing each embodiment of the present disclosure, some concepts involved in all embodiments of the present disclosure will be appropriately explained as follows.

1) Virtual Reality (VR for short), a technology for creating and experiencing virtual world, is determined to generate a virtual environment, which is a kind of multi-source information (the Virtual Reality mentioned in the present disclosure includes at least visual perception, but may also include auditory perception, tactile perception, motion perception, even taste perception, smell perception, etc.), which implements the integration and interactive three-dimensional dynamic vision and physical behavior simulation of virtual environment, so that users can be immersed in the simulated Virtual Reality environment, and the application in various virtual environments such as map, game, video, education, medical treatment, simulation, collaborative training, sales, assist manufacturing, maintenance and repair can be implemented..

2) Virtual reality devices (VR devices for short), terminals that implement virtual reality effects, may usually be provided in the form of glasses, a head mount display (HMD for short), and contact lenses to implement visual perception and other forms of perception. Of course, the implementation forms for the virtual reality devices are not limited to them, and may be further miniaturized or enlarged according to actual needs.

Optionally, the virtual reality devices described in the embodiments of the present disclosure may include, but are not limited to, the following types.

2.1) Computer-side virtual reality (PCVR) devices use the PC to perform related computation and data output of virtual reality functions, and the external computer-side virtual reality devices use the data output by the PC to implement the effect of virtual reality.

2.2) Mobile virtual reality devices support to set up mobile terminals (such as smartphones) in various ways (such as a head-mounted display equipped with special card slots). Through wired or wireless connections with the mobile terminals, the mobile terminals perform related computation on virtual reality functions and outputs data to the mobile virtual reality devices, such as watching mobile terminal videos through the virtual reality’s APP.

2.3) All-in-one virtual reality devices have a processor used for computation related to virtual functions, and thus have independent virtual reality input and output functions, do not need to be connected to a PC or mobile terminal, and have high freedom of use.

3) Virtual Field Of View: an area in the virtual environment that the user can perceive through a lens in the virtual reality device. The Field Of View (FOV) of the virtual field of view is used to represent a perceived area.

4) Augmented Reality (AR for short): a technology that computes ’camera posture parameters of a camera in the real world (or three-dimensional world, physical world) in real time during the process of collecting images by the camera, and adds virtual elements to the image collected by the camera according to the camera posture parameters. The virtual elements include but are not limited to: images, videos, and three-dimensional models. The goal of AR technology is to connect the virtual world on the screen to interact in the real world.

5) Mixed Reality (MR for short): an analog setting that integrates computer-created sensory input (e.g., a virtual object) with sensory input from a physical setting or a representation of the sensory input from a physical setting. In some MR settings, the computer-created sensory input can be adapted to changes in the sensory input from a physical setting. Additionally, some electronic systems for presenting the MR settings may monitor the orientation and/or position relative to the physical setting, so that the virtual object can interact with a real object (i.e., physical elements from a physical setting or representations thereof). For example, the system may monitor motion so that the virtual plant appears to be stationary relative to the physical building.

6) Extended Reality (XR for short) refers to all real and virtual combined environments and human-computer interactions generated by computer technology and wearable devices, and includes various forms such as Virtual Reality (VR), Augmented Reality (AR), and Mixed Reality (MR).

7) Virtual scene is a virtual scene that is displayed (or provided) when an application program is un on the electronic device. The virtual scene may be a simulation environment for the physical world, a semi-simulated and semi-fictional virtual scene, or a pure fictional virtual scene. The virtual scene may be any one of a two-dimensional virtual scene, a 2.5-dimensional virtual scene, or a three-dimensional virtual scene, and the dimensions of the virtual scene are not limited in the embodiments of the present disclosure. For example, the virtual scene may include sky, land, sea, etc., and the land may include environmental elements such as a desert and a city, and the user may control the virtual object to move in the virtual scene.

8) Virtual object is an object that interacts in the virtual scene, is controlled by a user or a robot program (for example, a robot program based on artificial intelligence), and may be an object that can stand still, move, and perform various behaviors in the virtual scene, such as various characters in a game.

In an actual scenario, a user may open a plurality of applications in the XR space, which is also referred to as a spatial multi-task scenario. The plurality of applications include an XR application and one or more traditional 2D applications. The XR space is 3D space, also known as VR space or 3D virtual space.

2D applications refer to traditional applications running on electronic device such as mobile phones, computers, and tablets. The image displayed by 2D applications to users is a 2D image. XR applications are also called 3D applications. 3D applications refer to applications running on XR devices. The image displayed by 3D applications to users is a 3D image. The 2D applications include, but are not limited to, video playback applications, short video applications, music applications, instant messaging application and shopping software, etc.

In a spatial multi-task scene, the content of the 2D application is projected into the XR space through perspective transformation. When the 2D application is initially opened, the content can be projected into the XR space according to a preset depth (i.e., the Z-axis coordinate), and the depth is usually large, that is, the 2D application is far away from the user in the XR space (which may also be understood as far away from the virtual camera of the XR space), which makes the panel of the 2D application occupy a small proportion in the display screen after the 2D application is projected into the XR space, resulting in the content of the 2D application being blurred.

In order to solve the problem that the content of the 2D application is blurred after the 2D application is projected into the XR space, an embodiment of the present disclosure provides a method of image rendering, which improves the definition of the content of the 2D application seen by the user.

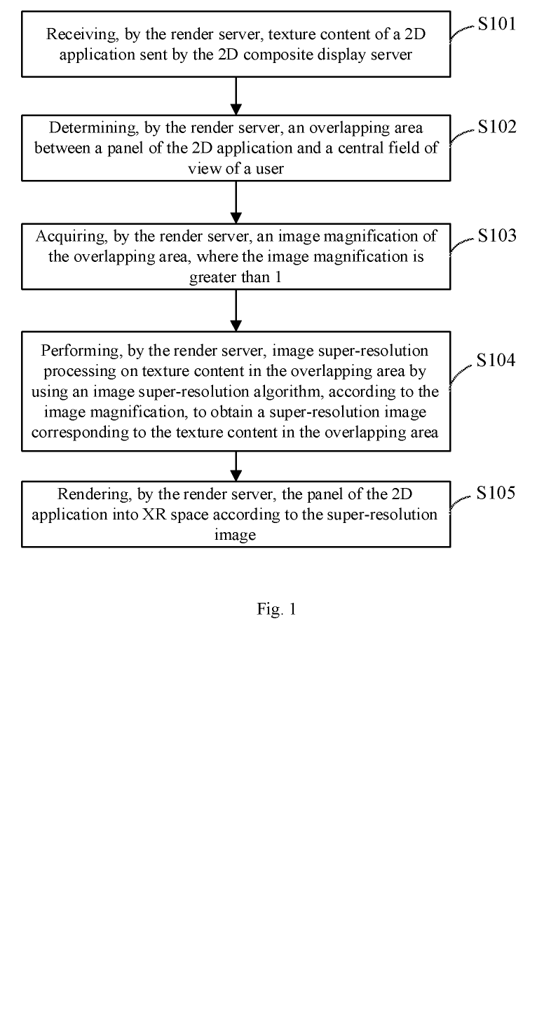

FIG. 1 is a schematic flow diagram of a method of image rendering according to an embodiment of the present disclosure, and the method is executed by an XR device. The XR device may be an integrated XR device (such as an HDM), or may be an external XR device. As shown in FIG. 1, the method provided by the present embodiment includes the following steps.

S101: receiving, by the render server, texture content of a 2D application sent by the 2D composite display server.

The XR device includes a 2D composite display server and a render server. The 2D composite display server is used to composite the content of the image buffer of the 2D application to obtain the texture content of the 2D application. In different operating system, the 2D composite display server has different names, for example, in the Android system, the 2D composite display server is a Surface Flinger server.

Surface Flinger server is a system server responsible for graphics rendering and display in the Android system. The Surface Flinger server can receive image buffers from multiple applications and system servers, and composite the image buffers according to the position, size, transparency, Z-axis order and other properties into a final buffer and then send the final buffer to the display device.

The render server is positioned in a rendering engine and is a service module independent of the application layer. The render server can simultaneously perform fusion rendering on the content of multiple applications (including 2D applications and XR applications) in the same space according to rendering instructions.

S102: determining, by the render server, an overlapping area between a panel of the 2D application and a central field of view of a user.

The central field of view (also known as a foveated area) usually refers to an area where the user’s eyes directly gaze and perceive it most clearly, and is the place with the highest visual sensitivity. In addition to the central field of view, the human field of view also includes other areas outside the central field.

It can be understood that the panel of the 2D application may or may not overlap with the central field of view. In the case where the panel of the 2D application overlaps with the central field of view, the overlapping area between the panel of the 2D application and the central field of view of the user is further determined. In the case where the panel of the 2D application does not overlap with the central field of view, the render server performs normal rendering operation on the panel of the 2D application, and renders the panel of the 2D application into the XR space. For the case where the panel of the 2D application overlaps with the central field of view, the following steps is followed.

In an implementation, whether an interactive ray (ray casting) in the XR space collides with the panel of the 2D application is detected. When the interactive ray collides with the panel of the 2D application, the panel of the 2D application is determined to be overlapped with the central field of view. A collision point between the interactive ray and the panel of the 2D application is used as a center point, a position of the central field of view is determined according to a preset size parameter of the central field of view. According to the position of the central field of view and a position of the 2D-applied panel, the overlapping area between the 2D-applied panel and the central field of view is determined.

The interactive ray is an important means of interaction in XR devices, usually refers to a virtual straight line emitted from a point (such as the user’s eyes, head, hands or controller) in one direction, and is used to detect collisions with the virtual environment or other virtual objects, implementing various interactive operation accordingly.

The XR device can control the interactive ray in a variety of interactive modes , and the interactive modes is also referred to as an Extended Reality Interaction model. The interaction modes of the XR devices include but are not limited to: Eye Tracking (ET) mode, controller mode, gesture recognition, etc.

The eye tracking mode is that by acquiring eye movement parameters such as the coordinate of the gaze point of a user’s eyes and the direction of the line of sight, the interactive ray (such as a gesture ray or a handle ray) in the XR space is controlled to move according to the eye movement parameters. The starting point of the rays moves following the user’s gaze point, so that the rays point to wherever the user’s eyes look.

The controller can be a handle, a bracelet, etc. The controller mode controls the interactive ray in the XR space to move by tracking the user’s hand motion.

During the extension process, the interactive ray may collide with other virtual objects in the XR space. When a collision is detected, the information of the collision object can be obtained. Based on the result of the collision detection, various interactive operations can be implemented, such as selecting an object, triggering an event, controlling a character to move, etc.

In the present embodiment, the render server determines whether the interactive ray in the XR space collides with the panel of the 2D application through collision detection, and when the interactive ray collides with the panel of the 2D application, it is determined that the panel of the 2D application overlaps with the central field of view. When the interaction ray does not collide with the panel of the 2D application, it is determined that the panel of the 2D application does not overlap with the central field of view.

When the interactive ray collides with the panel of the 2D application, the collision point between the interactive ray and the panel of the 2D application used as the center point, and the position of the central field of view is determined according to the preset size parameter of the central field of view. According to the position of the central field of view and the position of the 2D-applied panel, the overlapping area between the 2D-applied panel and the central field of view is determined.

The preset size parameter of the central field of view is used to define the size or area of the central field of view, and the central field of view may be circular, oval, rectangular, etc. The embodiment of the present disclosure does not limit the shape and size of the central field of view, and the shape and size of the central field of view can be flexibly adjusted according to the needs of actual application scenarios.

When the central field of view is elliptical, the size parameter of the central field of view is the length of the major axis and minor axis of the ellipse. When the central field of view is circular, the size parameter of the central field of view is the radius or length of the circle. When the central field of view is rectangular, the size parameter of the central field of view is the value of the length and width of the rectangle.

Taking the central field of view as the ellipse, the render server uses the expansion point as the center point, and forms an elliptical area as the central field of view according to the length of the major axis and minor axis of the predefined ellipse, and thus the position of the central field of view is obtained. According to the position of the central field of view and the position of the panel of the 2D application, the overlapping area of the two can be determined.

In another implementation, according to a coordinate of the panel of the 2D application in the XR space, a screen coordinate of the panel of the 2D application in the screen coordinate system after the panel of the 2D application is projected into the XR space is determined. According to the screen coordinate of the panel of the 2D application, whether the screen coordinate of the panel of the 2D application overlaps with a central region of a range of a screen coordinate corresponding to the XR space is determined. When the screen coordinate of the panel of the 2D application overlaps with the central region of the range of the screen coordinate corresponding to the XR space, the panel of the 2D application is determined to be overlapped with the central field of view. According to the coordinate of the panel of the 2D application in the XR space, the overlapping area between the panel of the 2D application and the central field of view is determined.

In the present implementation, the panel of the 2D application is projected into the XR space through perspective transformation, to obtain the projection position of the panel of the 2D application on the display screen (i.e., the screen coordinate of the panel of the 2D application in the screen coordinate system). Normally, the central field of view of the user is the center area of the display screen, so whether the screen coordinate of the panel of the 2D application overlaps with the center area of the range of the screen coordinate corresponding to the XR space is determined, and when the two overlap, it is determined that the panel of the 2D application overlaps with the central field of view.

For example, the step of determining the overlapping area between the panel of the 2D application and the central field of view according to the coordinate of the panel of the 2D application in the XR space, may be: using the central point of the panel of the 2D application as the central point, determining the position of the central field of view according to the size parameter of the central field of view, and determining the overlapping area according to the position of the central field of view and the position of the panel of the 2D application. Alternatively, according to an overlapping area between the screen coordinate of the panel of the 2D application and the central region of the range of the screen coordinate corresponding to the XR space, the overlapping area between the panel of the 2D application and the central field of view is determined.

S103: acquiring, by the render server, an image magnification of the overlapping area, where the image magnification is greater than 1.

The image magnification is used to magnify the image in the overlapping area of the panel of the 2D application, and the image magnification refers to the proportion of the image magnification. The image magnification is greater than 1.

In an implementation, the image magnification is a preset fixed magnification value.

In another implementation, according to a coordinate of the panel of the 2D application in the XR space, a screen-to-body ratio of a projection of the panel of the 2D application on a display screen and the display screen is determined, a reciprocal of the screen-to-body ratio is calculated, and the image magnification is determined according to the reciprocal of the screen-to-body ratio.

Optionally, the reciprocal of the screen-to-body ratio may be used as the image magnification. Since the value of the screen-to-body ratio is smaller than 1, the value of the image magnification is greater than 1. For example, when the screen-to-body ratio is 1/3, the image magnification is 3, when the screen-to-body ratio is 1/2, the image magnification is 2, and when the screen-to-body ratio is 10%, the image magnification is 10.

Optionally, the reciprocal of the screen-to-body ratio may further be adjusted to obtain the image magnification. For example, the image magnification may be obtained by adding or subtracting a preset adjustment factor to the reciprocal of the screen-to-body ratio.

For example, the screen-to-body ratio of the projection of the panel of the 2D application on the display screen and the display screen can be calculated by following: according to the coordinate of the panel of the 2D application in the XR space, determining a screen coordinate of the panel of the 2D application in a screen coordinate system after the panel of the 2D application is projected into the XR space through perspective transformation; determining a projection area of the panel of the 2D application on the display screen according to the screen coordinate of the panel of the 2D application; and calculating a ratio of the projection area of the panel of the 2D application on the display screen to an area of the display screen, and determining the ratio as the screen-to-body ratio.

When calculating the screen-to-body ratio, the display screen does not refer to the physical screen of the XR device, but refers to the visible area perceived by the user. The size of the visible area is related to the FOV of the virtual camera in the XR scene. When the FOV of the virtual camera is fixed, the size of the display screen is fixed. Therefore, the main factor affecting the screen-to-body ratio is the position of the panel of the 2D application in the XR space. When the panel of the 2D application is farther away from the camera, the projection of the panel of the 2D application on the display screen is smaller, and the corresponding screen-to-body ratio is smaller. When the panel of the 2D application is closer to the camera, the projection of the panel of the 2D application on the display screen is larger, and the corresponding screen-to-body ratio is larger.

It should be noted that in this step, instead of actually performing perspective transformation on the panel of the 2D application, the screen-to-body ratio after perspective transformation is calculated.

Taking the image size of the panel of the 2D application as “Size.x”: 1100.0 and “Size.y”: 750.0, in response to the panel of the 2D application being placed 2 meters away from the camera by default (i.e., the z-axis value of the 2D application panel), the FOV of the camera is 105 degrees, and the final calculated screen-to-body ratio of the projection of the panel of the 2D application on the display screen and the display screen is approximately 10%.

In an implementation, the perspective transformation projection process includes the following steps.

Step 1: acquiring a view matrix and a projection matrix for a camera.

Step 2: transforming the coordinate of the panel of the 2D application in the XR space to a cropped space coordinate system according to the view matrix and the projection matrix.

Step 3: converting a coordinate of the panel of the 2D application in the cropped space coordinate system to the screen coordinate system, to obtain the screen coordinate of the 2D application in the screen coordinate system.

The view matrix is used to convert an object in a scene from the world coordinate system to the camera coordinate system, in other words, it describes the position and orientation of the camera in the scene.

The projection matrix is used to project a point in the camera coordinate system on a normalized device coordinate (NDC), and then convert the normalized device coordinate to a two-dimensional coordinate system. This process involves perspective projection, and the perspective projection can simulate the effect of human eyes observing an object, that is, the distant object looks smaller. The projection matrix is related to parameters such as the distance to the near plane, the distance to the far plane, the aspect ratio of the screen, and FOV.

Through the view matrix and the projection matrix, three-dimensional vertices in the scene can be directly transformed from the world coordinate system to the two-dimensional screen coordinate system.

S104: performing, by the render server, image super-resolution processing on texture content in the overlapping area by using an image super-resolution algorithm, according to the image magnification, to obtain a super-resolution image corresponding to the texture content in the overlapping area.

Image Super-Resolution (SR) is a technology widely used in the fields of computer vision and image processing. Its purpose is to reconstruct a high-resolution (HR) image from a low-resolution (LR) image. The image super-resolution algorithm algorithmically generates clearer and more detailed high-resolution images, thus improving the visual effect of images.

Image Resolution (Image Resolution) is an important parameter to describe the clarity of image details, and refers to the amount of information stored in an image, which is specifically represented by the quantity of pixels included in image per unit length. In digital image processing, it is more commonly described in terms of the quantity of pixels of the width and height of an image. For example, the resolution of “1920x1080” represents that the width of image is 1920 pixels and the height is 1080 pixels.

The lower the resolution, the blurrier the image. The higher the resolution, the clearer the image. The resolution of a super-resolution image is equal to the product of the image magnification and the resolution of the texture content in the overlapping area. Assuming that the resolution of the texture content in the overlapping area is 1920x1080 and the image magnification is 2, the resolution of the super-resolution image is 3840x2160.

The image super-resolution algorithm may adopt traditional methods based on traditional signal processing technologies such as interpolation and filtering/filter (verb), or may adopt an image super-resolution model based on deep learning. The image super-resolution model can learn a mapping relationship from low-resolution images to high-resolution images, and reconstruct a high-resolution estimated image based on the mapping relationship.

Specifically, the texture content in the overlapping area and the image magnification are input to an image super-resolution model, and the image super-resolution model outputs a super-resolution image corresponding to the texture content in the overlapping area. The texture content in the overlapping area refers to content in the overlapping area among the texture content of the 2D application transmitted by the 2D composite display server.

For example, the image super-resolution model may be a convolutional neural network (CNN) model, a generative adversarial network (GAN) model, or an attention model.

Optionally, the image super-resolution algorithm may be Snapdragon Game Super Resolution (GSR) technology.

S105: rendering, by the render server, the panel of the 2D application into XR space according to the super-resolution image.

In the present embodiment, when the render server renders the panel of the 2D application into the XR space, the overlapping area and other areas on the panel of the 2D application are processed respectively, and the other areas refer to the remaining areas in the panel of the 2D application except the overlapping area.

In an implementation, the render server reads content of the super-resolution image from a first buffer, and projects the super-resolution image into the XR space through perspective transformation; reads, from a second buffer, content in other areas in the panel of the 2D application other than the overlapping areas, and projects the content in the other areas into the XR space through perspective transformation.

The texture content of the 2D application sent by the 2D composite display server is stored in the second buffer. When the render server performs image super-resolution processing on the texture content in the overlapping area by using the image super-resolution algorithm, the texture content in the overlapping area is read from the second buffer, and the processed super-resolution image is stored in the first buffer.

Since the resolution of the super-resolution image stored in the second buffer is higher than the resolution of the image of other areas stored in the first buffer, the first buffer is also referred to as a high-definition buffer, and the second buffer is also referred to as a low-definition buffer.

Through the above processing, in the screen finally displayed to the user, the image resolution of different areas of the panel of the 2D application is different, the resolution of the content in the overlapping area is higher than the resolution of the content in other areas, and the content in the overlapping area is clearer than the content in other regions. The overlapping area is positioned in the central field of view of the user, and thus improving the definition of the panel of the 2D application seen by the user, thereby improving the user experience.

For example, for a panel of a 2D application with an image size of “Size.x”: 1100.0 and “Size.y”: 750.0, in response to the panel of the 2D application being placed 2 meters away from a camera by default, and the FOV of the camera being 105 degrees, the calculated screen-to-body ratio is approximately 10%. A screen-to-body ratio of 10% means that after the panel of the 2D application is transformed to the XR space through perspective transformation, the size of the image on the screen seen by the user is only 110*75, the resolution of the panel of the 2D application is very low. In response to the overlapping area between the panel of the 2D application and the central field of view being performed super-resolution processing according to the image magnification of 10 (i.e., the screen-to-body ratio is the reciprocal of 10%), then the resolution of the super-resolution image in the overlapping region becomes 11000*7500. After the super-resolution image is transformed into the XR space through perspective transformation, the resolution of the image in the overlapping region is 1100*750, and the resolution of the image in other areas is 110*75, and therefore, the image of the panel of the 2D application seen by the user (i.e., the image in the overlapping area) is clear.

In the present embodiment, the render server can simultaneously perform fusion rendering on a plurality of 2D applications and XR applications in the same space (i.e., the XR space), so in another implementation, the render server can also perform spatial effect processing on the panel of the 2D application to generate various different rendering effects for the 2D application.

For example, the spatial effect processing includes at least one of following processing selected from the group consisting of lighting processing, feathering processing, or blurring processing. Specifically, the render server may add a sunlight effect or moonlight effect to the panel of the 2D application, may also feather the surroundings of the panel of the 2D application, or blur the back of the panel of the 2D application.

When the render server renders the super-resolution image in the overlapping area and the content in other areas to the XR space, the render server performs fusion rendering on the super-resolution image in the overlapping area, the texture content in other areas of the panel of the 2D application and the XR space (also called the current scene) together to obtain rendering data of a 3D image. It should be noted that the XR space may further include other 2D applications and/or XR applications, and when the render server performs fusion rendering, all 2D applications and/or XR applications are rendered together.

The render server stores the rendering data of the 3D image obtained by rendering into an eye buffer. The eye buffer may include a left eye buffer and a right eye buffer. The left eye buffer is used to store rendering data of the left eye, and the right eye buffer is used to store rendering data of the right eye.

The XR device further includes a compositor, which is positioned in the XR runtime and is used to read rendering data from the eye buffer and perform composite processing, and send the composited image to be displayed to a display for screen display.

The composite processing includes compositing a plurality of graph layers or composited layers included in the rendering data, and the composite processing further includes image distortion processing, etc. The final image used for the screen is generated by the processing of a compositer. The eye buffer includes the rendering data of the left eye and the rendering data of the right eye, and the compositer composites the rendering data of the left eye and the rendering data of the right eye respectively.

In the present embodiment, the render server receives the texture content of the 2D application sent by the 2D composite display server, determines an overlapping area between the panel of the 2D application and the central field of view of the user, and acquires an image magnification of the overlapping area, and the image magnification is greater than 1. The render server uses an image super-resolution algorithm to perform image super-resolution processing on texture content in the overlapping area according to the image magnification, to obtain a super-resolution image corresponding to the texture content in the overlapping area, and renders the panel of 2D application into the XR space according to the super-resolution image. The rendering service improves the resolution and definition of the panel content of the 2D application in the central field of view by performing super-resolution processing on the image in the overlapping area before rendering.

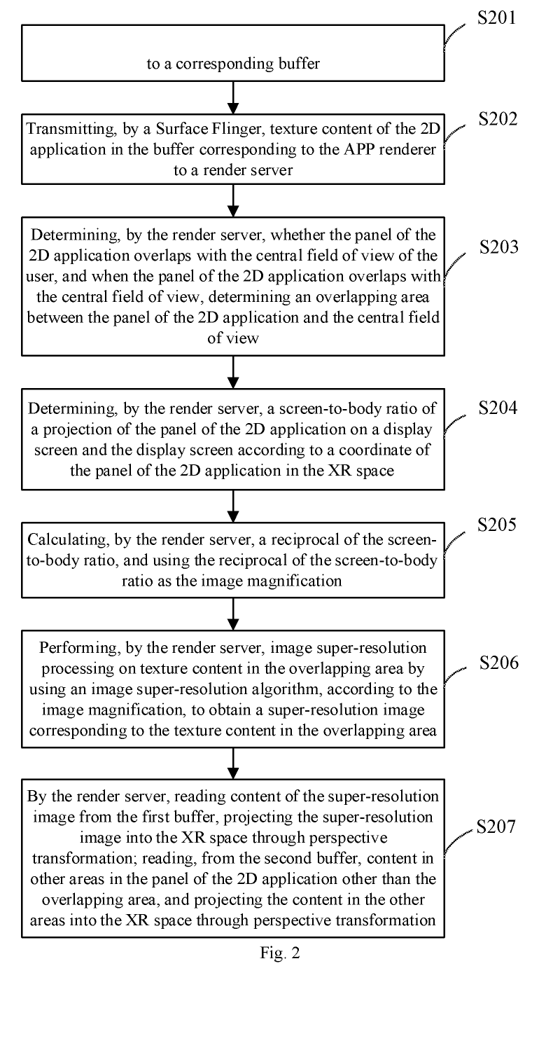

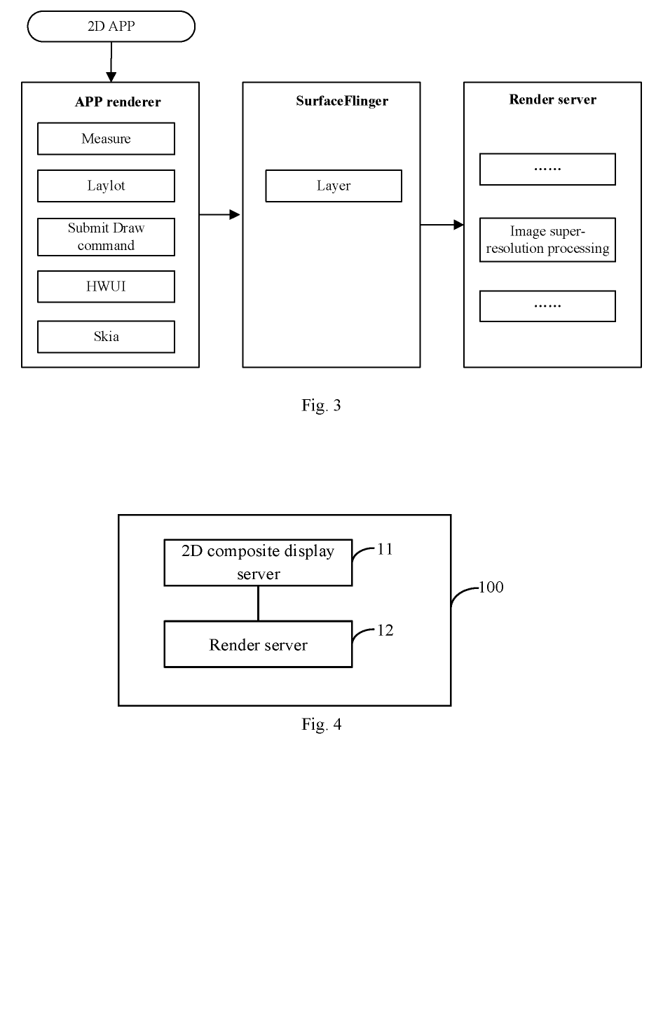

FIG. 2 is a flowchart of a method of image rendering provided by an embodiment of the present disclosure, FIG. 3 is a schematic diagram of a software architecture of an Android system to which an embodiment of the present disclosure is applicable, and the method of the present embodiment is described with reference to FIG. 2 and FIG. 3. As shown in FIG. 2, the method provided by the present embodiment includes the following steps.

S201: drawing, by an APP renderer, an image of a 2D application to a corresponding buffer.

S202: transmitting, by a Surface Flinger, texture content of the 2D application in the buffer corresponding to the APP renderer to a render server.

As shown in FIG. 3, the software architecture of the XR device includes: an APP renderer, a Surface Flinger and a render server. The APP renderer belongs to the application layer, and the Surface Flinger belongs to the system layer.

The APP renderer performs measure, layout and draw processing on the image of the 2D application, where the measure processing is used to determine the size (i.e., width and height) of the view of the image of the 2D application, and the layout processing is used to determine the position of the view of the image of the 2D application. The draw processing is used to draw the view of the image of the 2D application to the corresponding buffer (i.e., surface), and during the draw processing, the 2D image is rendered through the skia library and based on GPU-accelerated rendering engine for UI (Hardware Accelerated Rendering Engine for UI, HWUI for short). The Surface can be understood as a canvas of the 2D application, and the image of the 2D application is rendered to the canvas.

In an embodiment of the present disclosure, the Surface Flinger calculates the display attribute of the Surface in the space according to the attributes such as the position, transparency (e.g., translucent, fully transparent) and color of the view, and transmits the display attribute to the render server together with the Surface content.

Skia is an open source 2D graphics library that provides a complete suite of 2D drawing APIs capable of working across a variety of hardware and software platforms. HWUI is a component in the Android system, and is responsible for handling application’s UI rendering operations. By using GPU hardware drawing interface, the drawing efficiency and fluency are improved.

S203: determining, by the render server, whether the panel of the 2D application overlaps with the central field of view of the user, and when the panel of the 2D application overlaps with the central field of view, determining an overlapping area between the panel of the 2D application and the central field of view.

In response to the panel of the 2D application being not overlapped with the central field of the view of the user, the panel of the 2D application is directly rendered into the XR space without subsequent processing on the panel of the 2D application. In response to the panel of the 2D application being overlapped with the central field of view of the user, the method of the present embodiment is executed to render different areas of the panel of the 2D application, respectively.

S204: determining, by the render server, a screen-to-body ratio of a projection of the panel of the 2D application on a display screen and the display screen according to a coordinate of the panel of the 2D application in the XR space.

For example, according to the coordinate of the panel of the 2D application in the XR space, the render server determines a screen coordinate of the panel of the 2D application in a screen coordinate system after the panel of the 2D application is projected into the XR space through perspective transformation; determines a projection area of the panel of the 2D application on the display screen according to the screen coordinate of the panel of the 2D application; and calculates a ratio of the projection area of the panel of the 2D application on the display screen to an area of the display screen, and determines the ratio as the screen-to-body ratio.

S205: calculating, by the render server, a reciprocal of the screen-to-body ratio, and using the reciprocal of the screen-to-body ratio as the image magnification.

S206: performing, by the render server, image super-resolution processing on texture content in the overlapping area by using an image super-resolution algorithm, according to the image magnification, to obtain a super-resolution image corresponding to the texture content in the overlapping area.

The render server reads the texture content in the overlapping area from the second buffer. The texture content of the panel of the 2D application transmitted by the Surface Flinger is stored in the second buffer. The render server separately stores the super-resolution image obtained by super-resolution process into a buffer (i.e., the first buffer).

S207: by the render server, reading content of the super-resolution image from the first buffer, projecting the super-resolution image into the XR space through perspective transformation; reading, from the second buffer, content in other areas in the panel of the 2D application other than the overlapping area, and projecting the content in the other areas into the XR space through perspective transformation.

Some specific implementations of the present embodiment refer to the related description of the above embodiment, and will not be repeatedly described herein.

In order to facilitate better implementation of the method of image rendering according to the embodiment of the present disclosure, an embodiment of the present disclosure further provides an apparatus of image rendering. FIG. 4 is a schematic structural diagram of the apparatus of image rendering according to the embodiment of the present disclosure. As shown in FIG. 4, the apparatus of image rendering 100 may include a 2D composite display server 11 and a render server 12.

The 2D composite display server 11 is configured to process an image of a 2D application to obtain texture content of the 2D application.

The render server 12 is configured to receive the texture content of the 2D application sent by the 2D composite display server.

The render server 12 is further configured to determine an overlapping area between a panel of the 2D application and a central field of view of a user.

The render server 12 is further configured to acquire an image magnification of the overlapping area, and the image magnification is greater than 1.

The render server 12 is further configured to perform image super-resolution processing on texture content in the overlapping area by using an image super-resolution algorithm, according to the image magnification, to obtain a super-resolution image corresponding to the texture content in the overlapping area.

The render server 12 is further configured to render the panel of the 2D application into XR space according to the super-resolution image.

In some implementations, the render server 12 is specifically configured to:

determine a screen-to-body ratio of a projection of the panel of the 2D application on a display screen and the display screen according to a coordinate of the panel of the 2D application in the XR space; and

calculate a reciprocal of the screen-to-body ratio, and determine the image magnification according to the reciprocal of the screen-to-body ratio.

In some implementations, the render server 12 is specifically configured to:

determine, according to the coordinate of the panel of the 2D application in the XR space, a screen coordinate of the panel of the 2D application in a screen coordinate system after the panel of the 2D application is projected into the XR space through perspective transformation;

determine a projection area of the panel of the 2D application on the display screen according to the screen coordinate of the panel of the 2D application; and

calculate a ratio of the projection area of the panel of the 2D application on the display screen to an area of the display screen, and determine the ratio as the screen-to-body ratio.

In some implementations, the render server 12 is specifically configured to:

acquire a view matrix and a projection matrix for a camera;

transform the coordinate of the panel of the 2D application in the XR space to a cropped space coordinate system according to the view matrix and the projection matrix; and

convert a coordinate of the panel of the 2D application in the cropped space coordinate system to the screen coordinate system, to obtain the screen coordinate of the 2D application in the screen coordinate system.

In some implementations, the render server 12 is specifically configured to:

read content of the super-resolution image from a first buffer, and project the super-resolution image into the XR space through perspective transformation; and

from a second buffer, read content in other areas in the panel of the 2D application other than the overlapping area, and project the content in the other areas into the XR space through perspective transformation.

In some implementations, the render server 12 is further configured to perform spatial effect processing on the panel of the 2D application.

In some implementations, the spatial effect processing includes at least one of following processing selected from the group consisting of lighting processing, feathering processing, or blurring processing.

In some implementations, the render server 12 is specifically configured to:

detect whether an interactive ray in the XR space collides with the panel of the 2D application;

determine the panel of the 2D application being overlapped with the central field of view when the interaction ray collides with the panel of the 2D application;

determine a position of the central field of view according to a preset size parameter of the central field of view, and take a collision point between the interactive ray and the panel of the 2D application as a center point; and

determine the overlapping area according to the position of the central field of view and a position of the panel of the 2D application.

In some implementations, the render server 12 is specifically configured to:

determine a screen coordinate of the panel of the 2D application in a screen coordinate system after the panel of the 2D application is projected into the XR space according to a coordinate of the panel of the 2D application in the XR space;

determine, according to the screen coordinate of the panel of the 2D application, whether the screen coordinate of the panel of the 2D application overlaps with a central region of a range of a screen coordinate corresponding to the XR space;

determine the panel of the 2D application being overlapped with the central field of view when the screen coordinate of the panel of the 2D application overlaps with the central region of the range of the screen coordinate corresponding to the XR space; and

determine the overlapping area between the panel of the 2D application and the central field of view according to the coordinate of the panel of the 2D application in the XR space.

In some implementations, the render server 12 is specifically configured to input the texture content in the overlapping area and the image magnification to an image super-resolution model, where the image super-resolution model outputs the super-resolution image corresponding to the texture content in the overlapping area.

It should be understood that apparatus embodiments and method embodiments may correspond to each other, and similar descriptions may be made with reference to method embodiments. To avoid repetition, details will not be described here.

The apparatuses 100 and 200 of the embodiments of the present disclosure have been described above from the perspective of functional modules in conjunction with the drawings. It should be understood that the functional modules may be implemented in hardware form, by instructions in software form, or by a combination of hardware and software modules. Specifically, each step of the method embodiments in the embodiments of the present disclosure may be completed by an integrated logic circuit of hardware in the processor and/or by an instruction in the form of software. The steps of the method disclosed in conjunction with the embodiments of the present disclosure may be directly embodied as the execution of the hardware decoding processor, or may be completed by the execution of the combination of hardware and software modules in the decoding processor. Alternatively, the software modules may be located in a mature read-only memory in the art such as a random memory, a flash memory, a read-only memory, a programmable memory, an electrically erasable and writable programmable register, a storage medium, etc. The storage medium is located in a memory, and a processor reads the information in the memory and completes the steps of the above-described method embodiment in combination with its hardware.

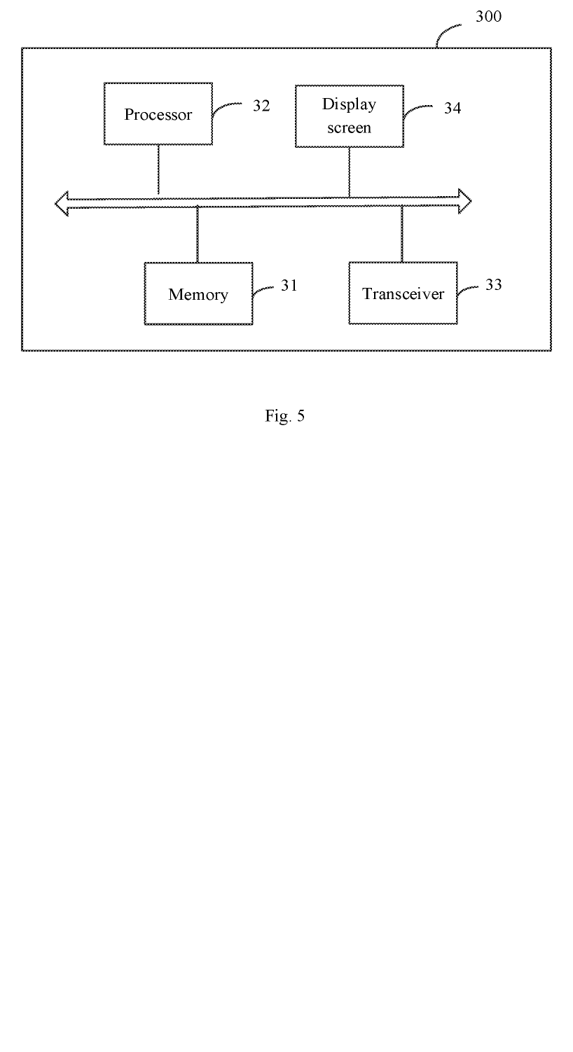

Embodiments of the present disclosure further provide an XR device. FIG. 5 is a schematic structural diagram of an XR device according to an embodiment of the present disclosure. As shown in FIG. 5, the XR device 300 may include a memory 31 and a processor 32.

The memory 31 is configured to store a computer program and transmit the program code to the processor 32. In other words, the processor 32 may call and run the computer program stored in the memory 31 to implement the method in the embodiments of the present disclosure.

For example, the processor 32 may be configured to execute method steps executed by the XR device or server in the above-described method embodiment according to the instructions in the computer program, and accordingly, the XR device 300 is an XR device or a server.

In some embodiments of the present disclosure, the processor 32 may include, but is not limited to: a general processor, a Digital Signal Processor (DSP), Application Specific Integrated Circuit (ASIC), Field a Programmable Gate Array (FPGA) or other programmable logic devices, discrete gate or transistor logic devices, discrete hardware components, etc.

In some embodiments of the present disclosure, the memory 31 includes, but is not limited to: a volatile memory and/or non-volatile memory. Among them, the non-volatile memory may be a Read-Only Memory (ROM), a Programmable Read-Only Memory (PROM), an Erasable PROM (EPROM), an Electrically EPROM (EEPROM), or a flash memory. The volatile memory may be a Random Access Memory (RAM), which serves as an external cache. By way of illustration, but not by way of limitation, many forms of RAM are available, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct internal memory bus random access memory (DR RAM).

In some embodiments of the present disclosure, the computer program may be divided into one or more modules, and the one or more modules are stored in the memory 31 and executed by the processor 32 to complete the method provided by the present disclosure. The one or more modules may be a series of computer program instruction segments capable of performing a specific function, and the instruction segments are used to describe the execution process of the computer program in the XR device.

As shown in FIG. 5, the XR device may further include a transceiver 33, a display screen 34, etc., and the processor 32 is electrically connected to the transceiver 33 and the display screen 34, respectively.

Here, the processor 32 may control the transceiver 33 to communicate with other devices, specifically, may transmit information or data to other devices, or receive information or data transmitted by other devices. The transceiver 33 may include a transmitter and a receiver. The transceiver 33 may further include antennas, and the quantity of the antennas may be one or more.

The display screen 34 may be used to display various virtual reality scene, VST videos, etc. The display screen 34 may use a single or two organic light emitting diode (OLED) displays, and other types of display solutions such as two smaller displays, micro displays, or flexible displays may of course be employed.

It can be understood that although not shown in FIG. 5, the XR device 300 may further include a camera module, a wireless fidelity WIFI module, a positioning module, a Bluetooth module, a power supply module, etc., and the description thereof will not be repeated here.

It should be understood that the various components in the XR device are connected by a bus system that includes a power supply bus, a control bus, and a status signal bus in addition to a data bus.

The present disclosure further provides a computer storage medium storing computer program thereon, and when the computer program is executed by a computer, the computer can execute the method that is executed by the XR device or the server in the above-described method embodiment, and the description thereof is not repeated herein.

The present disclosure further provides a computer program product, the computer program product includes a computer program, and the computer program is stored in a computer-readable storage medium. The processor of the XR device reads the computer program from computer-readable storage medium, and the processor executes the computer program, so that the XR device executes the method that is executed by the XR device in the above-described method embodiment, which is not repeated here.

In several embodiments provided in the present disclosure, it should be understood that the disclosed systems, apparatuses, and methods may be implemented in other ways. For example, the apparatus embodiments described above are merely schematic, for example, the division of the modules is only a logical function division, and there may be other division ways in actual implementation, for example, multiple modules or components may be combined or integrated into another system, or some features may be ignored or not implemented. In addition, the coupling or direct coupling or communication connection between each other shown or discussed may be an indirect coupling or communication connection through some interfaces, apparatuses or modules, which may be electrical, mechanical or otherwise.

The modules described as separate components may or may not be physically separate, and the components displayed as modules may or may not be physical modules, that is, they may be located in one place or may be distributed over a plurality of network units. Some or all of the modules may be selected according to actual needs to achieve the purpose of the solution of the present embodiment. For example, each functional module in each embodiment of the present disclosure may be integrated in one processing module, each module may physically exist separately, or two or more modules may be integrated in one module.

The above is only specific implementations of the present disclosure, but the scope of protection of the present disclosure is not limited thereto. Any person skilled in the art can easily think of changes or substitutions within the technical scope disclosed in the present disclosure, and should be covered within the scope of protection of the present disclosure. Therefore, the scope of protection of this application should be based on the scope of protection of claims.

1. A method of image rendering, applied to an extended reality XR device, wherein the XR device comprises a 2D composite display server and a render server, and the method comprises:
receiving, by the render server, texture content of a 2D application sent by the 2D composite display server;
determining, by the render server, an overlapping area between a panel of the 2D application and a central field of view of a user;
acquiring, by the render server, an image magnification of the overlapping area, wherein the image magnification is greater than 1;
performing, by the render server, image super-resolution processing on texture content in the overlapping area by using an image super-resolution algorithm, according to the image magnification, to obtain a super-resolution image corresponding to the texture content in the overlapping area; and
rendering, by the render server, the panel of the 2D application into XR space according to the super-resolution image.

2. The method according to claim 1, wherein the acquiring, by the render server, an image magnification of the overlapping area, comprises:
determining a screen-to-body ratio of a projection of the panel of the 2D application on a display screen and the display screen according to a coordinate of the panel of the 2D application in the XR space; and
calculating a reciprocal of the screen-to-body ratio, and determining the image magnification according to the reciprocal of the screen-to-body ratio.

3. The method according to claim 2, wherein the determining a screen-to-body ratio of a projection of the panel of the 2D application on a display screen and the display screen according to a coordinate of the panel of the 2D application in the XR space, comprises:
determining, according to the coordinate of the panel of the 2D application in the XR space, a screen coordinate of the panel of the 2D application in a screen coordinate system after the panel of the 2D application is projected into the XR space through perspective transformation;
determining a projection area of the panel of the 2D application on the display screen according to the screen coordinate of the panel of the 2D application; and
calculating a ratio of the projection area of the panel of the 2D application on the display screen to an area of the display screen, and determining the ratio as the screen-to-body ratio.

4. The method according to claim 3, wherein the determining, according to the coordinate of the panel of the 2D application in the XR space, a screen coordinate of the panel of the 2D application in a screen coordinate system after the panel of the 2D application is projected into the XR space through perspective transformation, comprises:
acquiring a view matrix and a projection matrix for a camera;
transforming the coordinate of the panel of the 2D application in the XR space to a cropped space coordinate system according to the view matrix and the projection matrix; and
converting a coordinate of the panel of the 2D application in the cropped space coordinate system to the screen coordinate system, to obtain the screen coordinate of the 2D application in the screen coordinate system.

5. The method according to claim 1, wherein the rendering, by the render server, the panel of the 2D application into XR space according to the super-resolution image, comprises:
reading content of the super-resolution image from a first buffer, and projecting the super-resolution image into the XR space through perspective transformation; and
reading, from a second buffer, content in other areas in the panel of the 2D application other than the overlapping area, and projecting the content in the other areas into the XR space through perspective transformation.

6. The method according to claim 5, wherein the rendering, by the render server, the panel of the 2D application into XR space according to the super-resolution image, further comprises:
performing spatial effect processing on the panel of the 2D application.

7. The method according to claim 6, wherein the spatial effect processing comprises at least one of following processing selected from the group consisting of: lighting processing, feathering processing, or blurring processing.

8. The method according to claim 1, wherein the determining an overlapping area between a panel of the 2D application and a central field of view of a user, comprises:
detecting whether an interactive ray in the XR space collides with the panel of the 2D application;
determining the panel of the 2D application being overlapped with the central field of view when the interaction ray collides with the panel of the 2D application;
determining a position of the central field of view according to a preset size parameter of the central field of view, taking a collision point between the interactive ray and the panel of the 2D application as a center point; and
determining the overlapping area according to the position of the central field of view and a position of the panel of the 2D application.

9. The method according to claim 1, wherein the determining an overlapping area between a panel of the 2D application and a central field of view of a user, comprises:
determining a screen coordinate of the panel of the 2D application in a screen coordinate system after the panel of the 2D application is projected into the XR space according to a coordinate of the panel of the 2D application in the XR space;
determining, according to the screen coordinate of the panel of the 2D application, whether the screen coordinate of the panel of the 2D application overlaps with a central region of a range of a screen coordinate corresponding to the XR space;
determining the panel of the 2D application being overlapped with the central field of view when the screen coordinate of the panel of the 2D application overlaps with the central region of the range of the screen coordinate corresponding to the XR space; and
determining the overlapping area between the panel of the 2D application and the central field of view according to the coordinate of the panel of the 2D application in the XR space.

10. The method according to claim 1, wherein the performing image super-resolution processing on texture content in the overlapping area by using an image super-resolution algorithm, according to the image magnification, to obtain a super-resolution image corresponding to the texture content in the overlapping area, comprises:
inputting the texture content in the overlapping area and the image magnification to an image super-resolution model, wherein the image super-resolution model outputs the super-resolution image corresponding to the texture content in the overlapping area.

11. An extended reality XR device, comprising: at least one processor and at least one memory,
wherein the at least one memory is configured to store a computer program, and the at least one processor is configured to call and run the computer program stored in the at least one memory to perform a method of image rendering,
the method is applied to an extended reality XR device, the XR device comprises a 2D composite display server and a render server, and the method comprises:
receiving, by the render server, texture content of a 2D application sent by the 2D composite display server;
determining, by the render server, an overlapping area between a panel of the 2D application and a central field of view of a user;
acquiring, by the render server, an image magnification of the overlapping area, wherein the image magnification is greater than 1;
performing, by the render server, image super-resolution processing on texture content in the overlapping area by using an image super-resolution algorithm, according to the image magnification, to obtain a super-resolution image corresponding to the texture content in the overlapping area; and
rendering, by the render server, the panel of the 2D application into XR space according to the super-resolution image.

12. The extended reality XR device according to claim 11, wherein the acquiring, by the render server, an image magnification of the overlapping area, comprises:
determining a screen-to-body ratio of a projection of the panel of the 2D application on a display screen and the display screen according to a coordinate of the panel of the 2D application in the XR space; and
calculating a reciprocal of the screen-to-body ratio, and determining the image magnification according to the reciprocal of the screen-to-body ratio.

13. The extended reality XR device according to claim 12, wherein the determining a screen-to-body ratio of a projection of the panel of the 2D application on a display screen and the display screen according to a coordinate of the panel of the 2D application in the XR space, comprises:
determining, according to the coordinate of the panel of the 2D application in the XR space, a screen coordinate of the panel of the 2D application in a screen coordinate system after the panel of the 2D application is projected into the XR space through perspective transformation;
determining a projection area of the panel of the 2D application on the display screen according to the screen coordinate of the panel of the 2D application; and
calculating a ratio of the projection area of the panel of the 2D application on the display screen to an area of the display screen, and determining the ratio as the screen-to-body ratio.

14. The extended reality XR device according to claim 13, wherein the determining, according to the coordinate of the panel of the 2D application in the XR space, a screen coordinate of the panel of the 2D application in a screen coordinate system after the panel of the 2D application is projected into the XR space through perspective transformation, comprises:
acquiring a view matrix and a projection matrix for a camera;
transforming the coordinate of the panel of the 2D application in the XR space to a cropped space coordinate system according to the view matrix and the projection matrix; and
converting a coordinate of the panel of the 2D application in the cropped space coordinate system to the screen coordinate system, to obtain the screen coordinate of the 2D application in the screen coordinate system.

15. The extended reality XR device according to claim 11, wherein the rendering, by the render server, the panel of the 2D application into XR space according to the super-resolution image, comprises:
reading content of the super-resolution image from a first buffer, and projecting the super-resolution image into the XR space through perspective transformation; and
reading, from a second buffer, content in other areas in the panel of the 2D application other than the overlapping area, and projecting the content in the other areas into the XR space through perspective transformation.

16. A non-transitory computer-readable storage medium, wherein the non-transitory computer-readable storage medium is configured to store a computer program, and the computer program causes a computer to perform a method of image rendering,
the method is applied to an extended reality XR device, the XR device comprises a 2D composite display server and a render server, and the method comprises:
receiving, by the render server, texture content of a 2D application sent by the 2D composite display server;
determining, by the render server, an overlapping area between a panel of the 2D application and a central field of view of a user;
acquiring, by the render server, an image magnification of the overlapping area, wherein the image magnification is greater than 1;
performing, by the render server, image super-resolution processing on texture content in the overlapping area by using an image super-resolution algorithm, according to the image magnification, to obtain a super-resolution image corresponding to the texture content in the overlapping area; and
rendering, by the render server, the panel of the 2D application into XR space according to the super-resolution image.

17. The non-transitory computer-readable storage medium according to claim 16, wherein the acquiring, by the render server, an image magnification of the overlapping area, comprises:
determining a screen-to-body ratio of a projection of the panel of the 2D application on a display screen and the display screen according to a coordinate of the panel of the 2D application in the XR space; and
calculating a reciprocal of the screen-to-body ratio, and determining the image magnification according to the reciprocal of the screen-to-body ratio.

18. The non-transitory computer-readable storage medium according to claim 17, wherein the determining a screen-to-body ratio of a projection of the panel of the 2D application on a display screen and the display screen according to a coordinate of the panel of the 2D application in the XR space, comprises:
determining, according to the coordinate of the panel of the 2D application in the XR space, a screen coordinate of the panel of the 2D application in a screen coordinate system after the panel of the 2D application is projected into the XR space through perspective transformation;
determining a projection area of the panel of the 2D application on the display screen according to the screen coordinate of the panel of the 2D application; and
calculating a ratio of the projection area of the panel of the 2D application on the display screen to an area of the display screen, and determining the ratio as the screen-to-body ratio.

19. The non-transitory computer-readable storage medium according to claim 18, wherein the determining, according to the coordinate of the panel of the 2D application in the XR space, a screen coordinate of the panel of the 2D application in a screen coordinate system after the panel of the 2D application is projected into the XR space through perspective transformation, comprises:
acquiring a view matrix and a projection matrix for a camera;
transforming the coordinate of the panel of the 2D application in the XR space to a cropped space coordinate system according to the view matrix and the projection matrix; and
converting a coordinate of the panel of the 2D application in the cropped space coordinate system to the screen coordinate system, to obtain the screen coordinate of the 2D application in the screen coordinate system.

20. The non-transitory computer-readable storage medium according to claim 16, wherein the rendering, by the render server, the panel of the 2D application into XR space according to the super-resolution image, comprises:
reading content of the super-resolution image from a first buffer, and projecting the super-resolution image into the XR space through perspective transformation; and
reading, from a second buffer, content in other areas in the panel of the 2D application other than the overlapping area, and projecting the content in the other areas into the XR space through perspective transformation.
